(19) United States
(12) Patent Application Publication
(10) Pub. No.: US 2006/0245560 A1
(43) Pub. Date: Nov. 2, 2006

(54) Programable caller ID alerting indicator for handheld device

(76) Inventor: Yau-Ren Jeng, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/117,407

(22) Filed: Apr. 29, 2005

(51) Int. Cl. H04M 1/64

(52) U.S. Cl. 379/88.19

(57) ABSTRACT

A method of identifying a second caller when a handheld device is busy with a first caller, comprising the steps of: (a) receiving an ID from the second caller; (b) comparing the ID of the second caller with an ID database of the handheld device for finding out corresponding call waiting data; and (c) outputting a call-waiting signal corresponding to the call waiting data. Hence the method can alert a mobile phone user via a sound signal, a light signal, a vibration signal or a combination thereof to know that who is a second caller without looking a caller display. Thereby the user can determine to receive the calling or not from the second caller without looking the caller display.

### BACKGROUND OF THE INVENTION

1. Field of the invention

The present invention relates to an identity notification for call waiting, and more particularly to a telephone system having call waiting that allows the user to knows who the second caller is that is calling without having to look at the caller display to determine whether to answer the call or not.

2. Description of the Prior Art

Many of today's telecommunication companies provide a three-party call service, i.e. while already engaged in one telephone call, the telecommunication company, upon receiving a call from second caller, will send a prompt tone so that the user can know they have another caller attempting to contact them. At the same time they will also transmit the number from which the second caller is calling from so that the user can see the number on the display of their telephone. If the user has a communication device (such as a mobile phone), they cannot continue their conversation and look at the display simultaneously; hence this method is inconvenient and can be improved upon.

U.S. Pat. No. 6,714,637 disposes an audio alerting announcement that alerts a user during an ongoing call with a distinctive tone to indicate the identity of another party who is trying to call the subscriber. However, it is inconvenient for users because they have to edit their contact information in the telecommunication company's server over the Internet. Moreover, many telecommunication companies don't provide this service as a part of their standard services.

### SUMMARY OF THE INVENTION

The primary objective of the present invention is a method for alerting a mobile phone user via a sound signal, a light signal, a vibration signal or a combination thereof to know that who is a second caller without looking a caller display. Thereby the user can determine to receive the calling or not from the second caller without looking the caller display.

For achieving the objective stated above, the present invention provides a method of identifying a second caller when a handheld device is busy with a first caller, comprising the steps of: (a) receiving an ID from the second caller; (b) comparing the ID of the second caller with an ID database of the handheld device for finding out corresponding call waiting data; and (c) outputting a call-waiting signal corresponding to the call waiting data. Furthermore, the present invention also provides a method of alerting indicator for a first communication device that is busy, comprising the steps of: (a′) connecting with a second communication device, and maintaining the connection status; (b′) receiving a call waiting notification from a third communication device; (c′) comparing a data transmitted from the third communication device with a database of the first communication device to find out corresponding data; and (d′) outputting a call waiting signal corresponding to the data.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

FIG. 1 is a flowchart showing a method for identifying a second caller when a handheld device is busy with a first caller according to the preferred embodiment of the present invention; and

FIG. 2 is a flowchart showing a method for identifying a second caller when a handheld device is busy with a first caller according to another embodiment of the present invention.

### DETAILED DESCRIPTION OF THE PREFERRED EMBODIMENTS

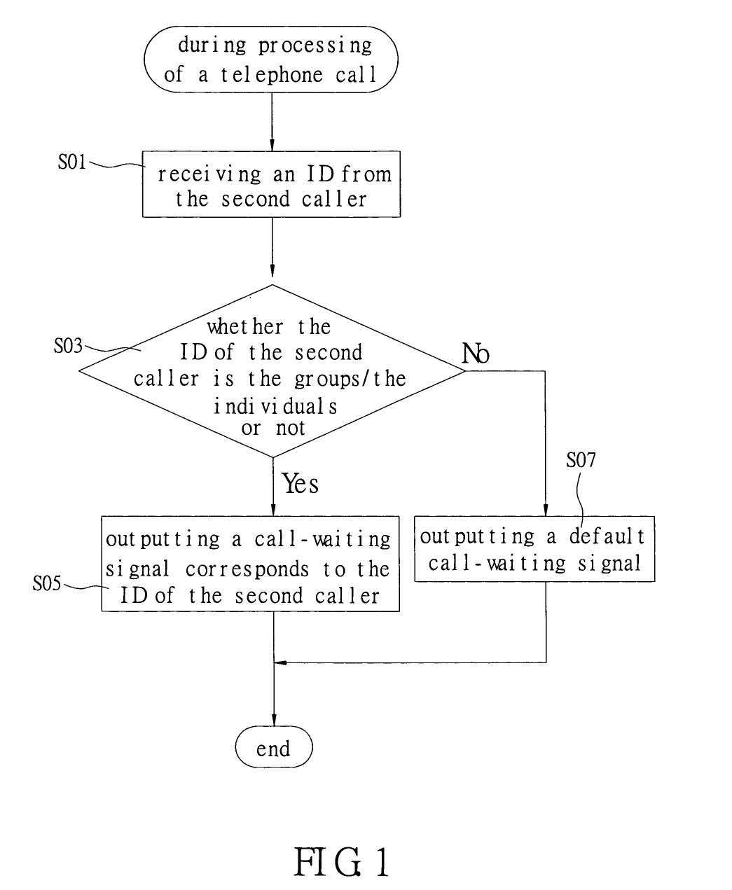

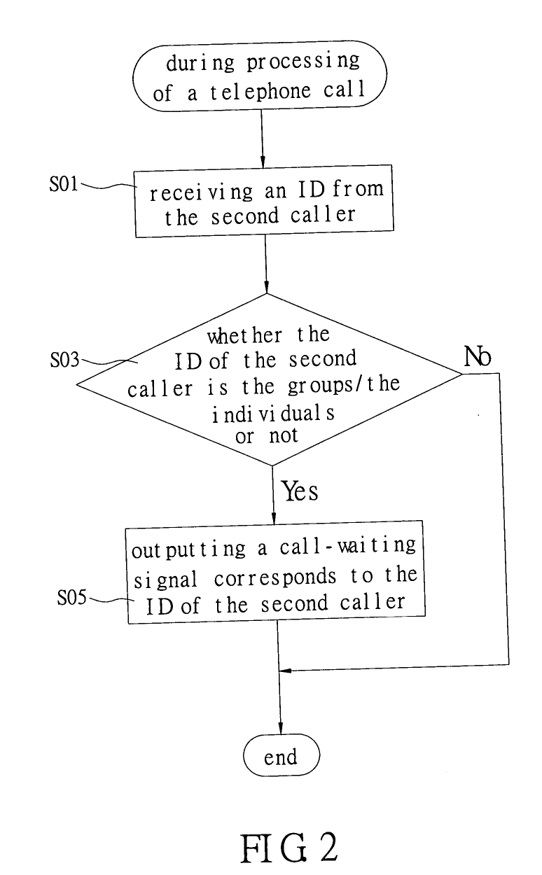

Reference is made to FIG. 1 and FIG. 2. The present invention provides a method for identifying a second caller when a handheld device is busy with a first caller. The method uses call-waiting signals (such as a voice signal, a light signal, a vibration signal or a combination thereof) the user is made aware of the identity of the second caller that is calling without having to look at the caller display, thereby allowing the user to determine whether or not to answer to answer the call without having to disrupt them from the call they are presently engaged in.

The method of call waiting is applicable to a handheld device during a telephone call. The handheld device has a database of identifying data (including IDs and other corresponding information). First, the user needs to input contact information onto the database of their handheld device. Each packet of identifying data includes at least an ID and a corresponding name. The data stored on the database can be classified into as many groups (such as the friends, coworkers, classmates, family members, partner, boss, important customers, or so on.) according to the individual user. Moreover, the user can set the particular call-waiting signals while the second caller is calling according their membership in one of these preset groups, or they can set an individual tone for a caller. After they are set, the call-waiting signals are stored the database of the handheld device.

The call-waiting signals are outputted by the handheld device, and each of the call-waiting signals can be a voice signal (such as tinkles, music, sound effects, a recorded speech or a combination thereof), a light signal, or a vibrating signal; it is also possible to have a combination of a voice signal, a light signal, and/or a vibration signal as a call-waiting signal. For instance, a combination of tinkles and a vibration, a music and a light, and so on in order to discriminate the identity of the second caller. Thereof, the recorded speech voice signal can be recorded by the user or the caller who is being assigned that personalized call-waiting signal; the light signal can be a flash with various colors or various frequencies; and the vibration signal can have different vibration modes or vibrating frequencies.

Reference is made to FIG. 1, which is a flowchart showing a method for identifying a second caller when a handheld device is busy with a first caller according to a preferred embodiment of the present invention. The method comprising the steps of:

receiving a call from a second caller during another telephone call already in progress (S01);

comparing the ID of the second caller with the IDs of groups or individuals stored on the handheld device's database (S03);

the call waiting signal is a default call waiting signal if the ID database does not have a call waiting data corresponding to the ID of the second caller (S07);

outputting a call-waiting signal corresponding to the data if the ID from the second caller corresponds to the data (S05).

In the step (S05) if the second caller's ID does not have a corresponding data stored on the handheld device's database, or if the second caller's ID can not be found on the handheld device's database, then the handheld device outputs a default call-waiting signal (S07). Thereof the default call-waiting signal is defined as a call-waiting signal assigned to calls from unimportant people or unknown people so the user will know it is unnecessary to interrupt or discontinue an important call. Alternatively, the handheld device can be preset to not output any default call-waiting signal (shown in S03 in FIG. 2 as a “false” result).

Upon finding an ID from the second caller stored on the database with corresponding data, the handheld device outputs a call-waiting signal corresponding to the data (S05) so the user can be made aware of the identity of the second caller and determine whether to answer the call or not.

The identity of a second caller can be made known to user of the present invention by a personalized identifying call-waiting signal or a default call-waiting signal. Upon a telephone call from a second caller during another telephone call that is already in progress, the user is made aware of the identity of the second caller that is calling by a personalized call-waiting signal. As such, the user doesn't have to look at the caller display, thereby allowing the user to determine whether or not to answer to answer the call without having to disrupt the call they are presently engaged in.

Upon a telephone call from a second caller during another telephone call that is already in progress, if the ID corresponds to data stored in the “friends” group of the of the database (hereforthwith described as ‘the first data’) and also corresponds to data stored as an individual's data (hereforthwith described as ‘the second data’). Because the second data has a higher priority than the first data, by outputting a call-waiting signal corresponding to the second data, the user will be made aware that the caller is important. In other words, if a person calls from an ID corresponding to at least two data stored on the handheld device, then the call-waiting signal corresponding to the data stored on individual list of the data will be activated; the call-waiting signal stored on the group list will not be activated.

A second embodiment provides another method of alerting indicator for a first communication device that is busy. The method comprises the steps of:

connecting with a second communication device, and maintaining the connection status;

receiving a call-waiting notification from a third communication device;

comparing a data transmitted from the third communication device to the data in the database of the first communication device for finding out corresponding data; and

outputting a call-waiting signal corresponding to the data.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method of identifying a second caller when a handheld device is busy with a first caller, comprising the steps of:
(a) receiving an ID from the second caller;
(b) comparing the ID of the second caller with an ID database of the handheld device for finding out corresponding call waiting data; and
(c) outputting a call-waiting signal corresponding to the call waiting data.

2. The method of claim 1, wherein the call-waiting signal is a voice signal, a light signal, a vibration signal, or a combination thereof.

3. The method of claim 2, wherein the voice signal is tinkles, music, sound effects, a recorded speech, or a combination thereof.

4. The method of claim 2, wherein the light signal is a flash with various colors, flicker frequencies, or a combination thereof.

5. The method of claim 2, wherein the vibration signal has various vibration modes, vibration frequencies, or a combination thereof.

6. The method of claim 1, wherein the call waiting signal is a default call waiting signal if the ID database does not have a call waiting data corresponding to the ID of the second caller.

7. The method of claim 1, wherein the database has at least one ID and a corresponding call waiting data.

8. The method of claim 1, wherein the call waiting signal is an individual call waiting data of the corresponded call waiting data if the ID database has at least two call waiting data corresponding to the ID of the second caller and the least two call waiting data comprises the individual call waiting data.

9. A method of alerting indicator for a first communication device that is busy, comprising the steps of:
(a′) connecting with a second communication device, and maintaining the connection status;
(b′) receiving a call waiting notification from a third communication device;
(c′) comparing a data transmitted from the third communication device with a database of the first communication device to find out corresponding data; and
(d′) outputting a call waiting signal corresponding to the data.

10. The method of claim 9, wherein the database has at least one identified datum and a corresponding data.

11. The method of claim 9, wherein the database has at least one group of identified data and a corresponding data, and the group of identified data has at least one identified datum.

12. The method of claim 9, wherein the call waiting signal is a voice signal, a light signal, a vibration signal, or a combination thereof.

13. The method of claim 12, wherein the voice signal is tinkles, music, sound effects, a recorded speech, or a combination thereof.

14. The method of claim 12, wherein the light signal is a flash with various colors, flicker frequencies, or a combination thereof.

15. The method of claim 12, wherein the vibration signal has various vibration modes, vibration frequencies, or a combination thereof.

16. The method of claim 9, wherein the call waiting signal is a default call waiting signal if the ID database does not have a call waiting data corresponding to the ID of the second caller.
